(19) United States
(12) Patent Application Publication
(10) Pub. No.: US 2008/0288650 A1
(43) Pub. Date: Nov. 20, 2008

(54) Method for the Energy-Saving and Timely Transmission of Event Messages

(75) Inventor: Andreas Kopetz, Baden-Siegenfeld (AT)

Correspondence Address: RATNERPRESTIA, P O BOX 980, VALLEY FORGE, PA, 19482-0980, US

(73) Assignee: FTS Computerchnik GmbH, Baden-Siegenfeld (AT)

(21) Appl. No.: 11/911,692

(22) PCT Filed: Apr. 18, 2006
(86) PCT No.: PCT/AT2006/000154

§ 371 Date: May 19, 2008

(30) Foreign Application Priority Data
Apr. 18, 2005 (AT) A 645/2005

(51) Int. Cl. G06F 13/28; G06F 15/16; H04L 7/00

(52) U.S. Cl. 709/230; 719/314

(57) ABSTRACT

A method and a system-on-a-chip for the guaranteed and energy-saving transmission of event messages is provided in a distributed computer system consisting of a plurality of node computers, which are interconnected by a time-controlled communications system. The node computers establish a common time base of known precision and periodically exchange messages at a prior defined points in time. A guaranteed event message is sent in a sporadic time-controlled message (SZN). The sporadic time-controlled message transports the guaranteed event message and is sent only if the content of this sporadic time-controlled message has been changed since the last time it was sent. The receiver stores the content of an incoming sporadic time-controlled message in a queue until the receiving process has read this content exactly once in a consuming manner.

The invention relates to a method according to the pre-characterising clause of claim 1 for the timely, deterministic and energy-saving transmission of event messages in a distributed real-time computer system. This method can also be used for the timely transmission of event messages within a system-on-a-chip (SoC), which contains several virtually autonomous microcomponents.

The invention also relates to a system-on-a-chip.

A distributed fault tolerant real-time computer system consists of a number of computer nodes, which each include a host computer, a communications controller, an I/O system for process peripherals and the necessary software (real-time operating system, middleware and application software). We describe such a computer node as a microcomponent when it is implemented as a virtually autonomous unit on an SoC (system-on-chip). Together with their data connections, the communications controllers form a real-time communications system by means of which state data and event data are exchanged.

State data are data, which provide information relating to the observed value of state variables. An observance of a state variable is an indivisible triple

<Name of State Variable, Value of State Variable, Time of Observation>

as described in detail in Kopetz, H. (1997). Real-Time Systems, Design Principles for Distributed Embedded Applications; ISBN: 0-7923-9894-7. Boston. Kluwer Academic Publishers. P. 31. An example of a state data element is the current position of a valve. A message, which contains state information, is called a state message.

Event data are data, which provide information relating to a change of state. An example of an event data element is the statement that the position of a valve has changed by 5 degrees. The event data provide information relating to the difference between the old state and the new state. As the loss (or a duplication) of an event data element results in a loss of the state synchronisation between transmitter and receiver, event data must be consumed exactly once by the receiver. A message, which contains event data, is called an event message. If a process changes very quickly (e.g. if a pipe in a factory becomes defective), then very many event messages (alarm messages) can occur within a short time interval, which can lead to an overloading of the communications system. In real-time data processing, it is therefore expedient to differentiate between guaranteed event messages and best-effort event messages. Guaranteed event messages must always be transmitted in a timely manner within the given error hypothesis. Best-effort event messages can be delayed in the critical high-load case.

As every change of state represents an event, there is a close correlation between state data and event data. On a high level of abstraction, it is possible to map the one transmission form onto the other. However, in a real application, large differences can occur in the efficiency of implementation between these two types of data transmission. If, for example, the state of an object only changes very rarely (e.g. an alarm message), then the periodic trans-mission of state data can lead to the data transmission being highly inefficient. On the other hand, the periodic transmission of state data provides a high measure of predictability and safety.

In the present invention, a method is disclosed, which makes it possible to ensure the timely transmission of all guaranteed event messages with minimum energy consumption in the high-load case.

This method represents a further development of the method for the transmission of event messages in a time-controlled communications system disclosed in European Patent EP 1 370 952. The further development consists in the fact that differentiation is made between guaranteed and best-effort event messages, and the bandwidth, which is not normally required, is left free for the transmission of guaranteed event messages for the purpose of saving energy or is made available for transmitting best-effort messages.

The object of the present invention is to guarantee timeliness, determinism and minimum energy consumption in the transmission of event messages in a distributed time-controlled real-time computer system. This object is achieved with a method for the guaranteed and energy-saving transmission of event messages in a distributed computer system consisting of a plurality of node computers, which are interconnected by means of a time-controlled communications system, and where the node computers establish a common time base of known precision and where the node computers can periodically exchange messages at a priori defined points in time, wherein, according to the invention, a guaranteed event message is sent in a sporadic time-controlled message (SZN), such a sporadic time-controlled message that transports an event message being sent only if the content of this sporadic time-controlled message has been changed since the last time it was sent, and where the receiver stores the content of an incoming sporadic time-controlled message in a queue until the receiving process has read this content exactly once in a consuming manner.

A communications system is therefore set up, which reserves a periodically recurring exclusive transmission slot for each guaranteed event message, which is only used, however, if a new event message has appeared in the previous period. The bandwidth, which is not normally required, can be left free for the purpose of energy saving or used for the transmission of best-effort event messages. Such a deterministic communications system can also be used for connecting microcomponents on a system-on-a-chip (SoC). In such an SoC system, the minimisation of the energy consumption is of particular interest.

The object described above and other new characteristics of the present invention are explained in the attached drawings.

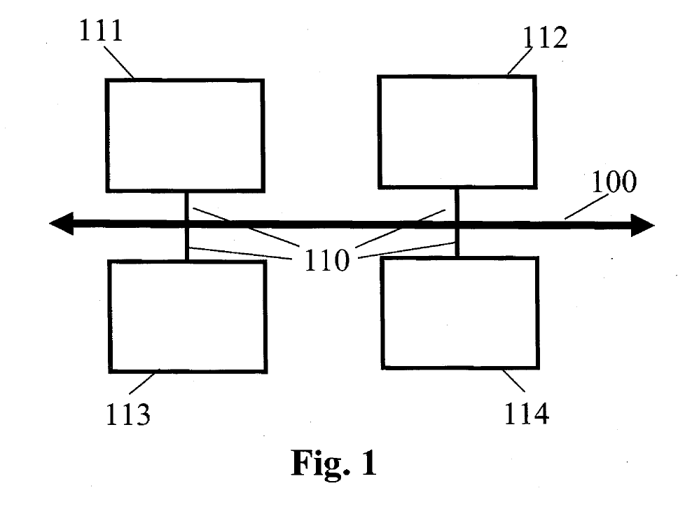

FIG. 1 shows the structure of a distributed real-time computer system.

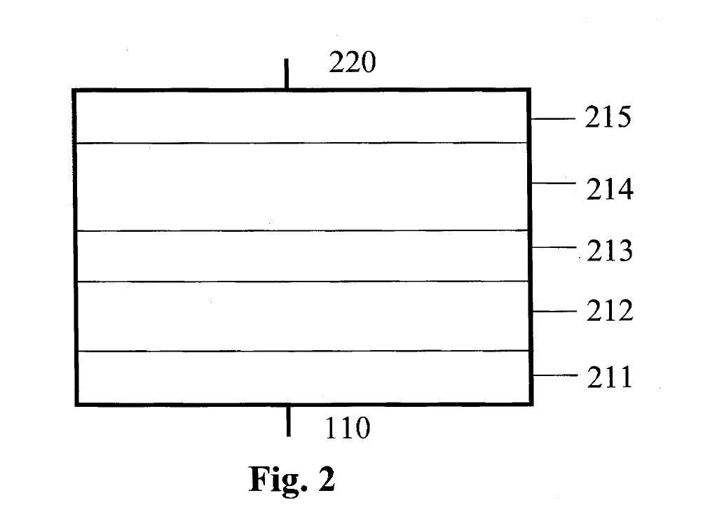

FIG. 2 shows the structure of a computer node of such a distributed computer system.

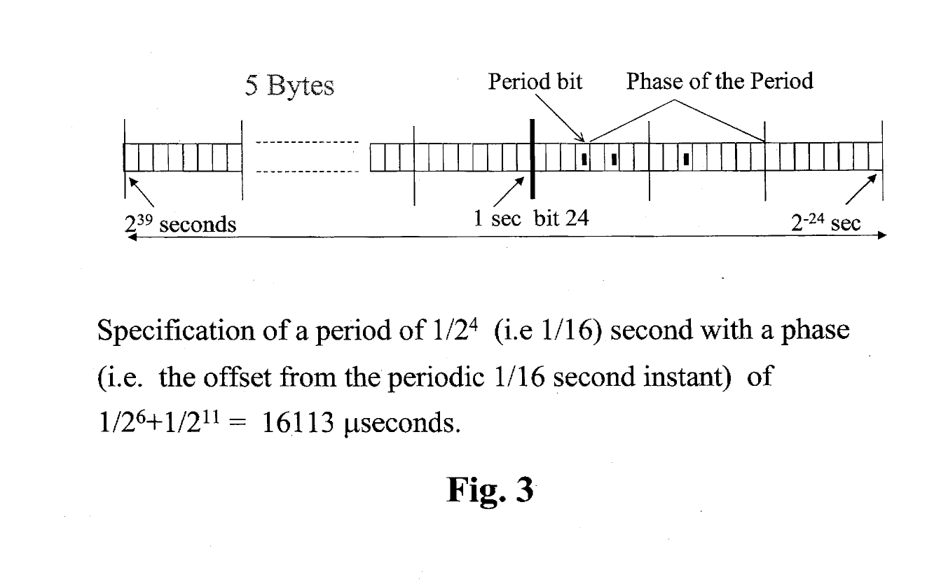

FIG. 3 shows a possible format for representing time.

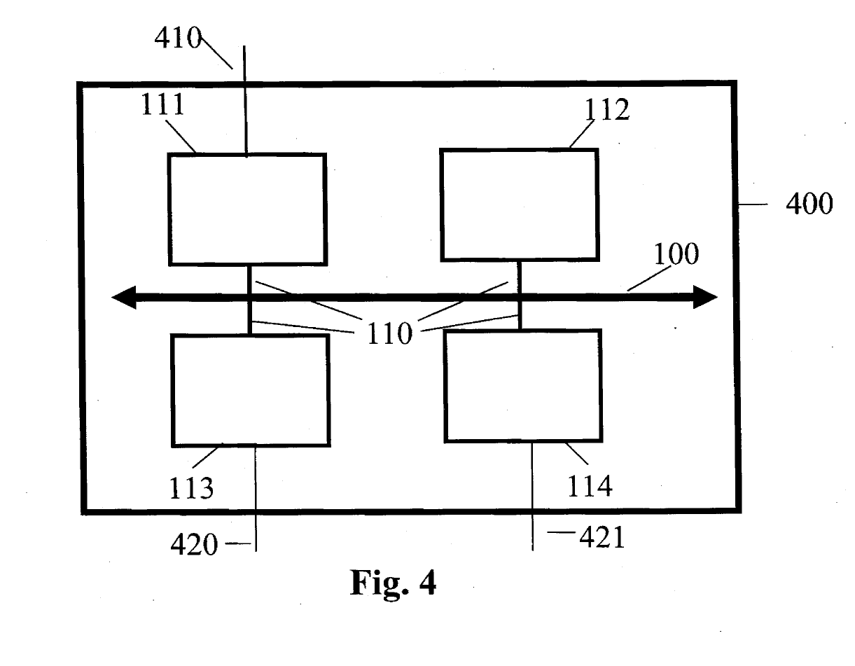

FIG. 4 shows an SoC (system-on-a-chip) with four microcomponents.

In the following section, one of the many possible specific realisations of the new method is shown using as an example a distributed real-time system with four computer nodes, which are connected by means of a real-time communications system. In the general case, state data and event data must be exchanged via such a real-time communications system.

The invention is now explained with reference to the diagrams:

FIG. 1 shows a distributed computer system, which consists of four node computers 111, 112, 113 and 114, which are connected to the communications system 100 by means of a time-controlled communications channel 110. This time-controlled communications system can exchange messages in accordance with a time plan, wherein the messages can contain state data or event data (or both). The communications system 100 can be designed as a data bus or by means of a central switch, which maintains point-to-point connections with the node computers 111, 112, 113, and 114. If the reliability of a single-channel communications system 100 is not adequate, then a two or multi-channel communications system can be used. Examples of such communications systems can be found in EP 1 370 952 and AT 411 498.

Within the framework of the invention, differentiation is made between the following three categories of message: (i) State messages, which are sent periodically, contain state information and whose transport within the given error hypothesis is guaranteed in time, (ii) guaranteed event messages, these are messages which contain event information and whose transport within the given error hypothesis is guaranteed in time, and (iii) best-effort event messages, these are messages which contain event information and whose timely transportation cannot be guaranteed in the high-load case. The message category of a particular message is specified by a special identifier (e.g. an identification field) in the header of each message. In doing so, only the periodic state messages for clock synchronisation may be called upon U.S. Pat. No. 5,694,542. An accurate description of the characteristics of event and state messages can be found in Kopetz, H. (1997). Real-Time Systems, Design Principles for Distributed Embedded Applications; ISBN: 0-7923-9894-7. Boston. Kluwer Academic Publishers., P. 32.

FIG. 2 shows the structure of a node computer 111, which comprises the following subsystems: the time-controlled communications controller 211 with the connection 110 to the time-controlled communications system 100, the node hardware with the real-time operating system 212, the middleware software 213, the application software 214 and a controller 215 with the line 220 to the remote transducers in the process. The time-controlled communications controller 211 periodically sends messages from its message store in accordance with a global time plan, which ensures that all messages are transported without conflict. Such a time-controlled communications system is described in EP 0 658 257 and U.S. Pat. No. 5,887,143.

In order to simplify the production of the time plan by a global scheduler, it can be defined that all periods of the communications system 100 must be in a harmonic ratio to the second, i.e. either 1 second, ½ second, ¼ second etc or 2 seconds, 4 seconds, 8 seconds etc. A period can then be characterised by the period duration and the period phase, that is the offset of the start of the second from the start of the period. If only sixteen different periods are provided in a system, then the period duration can be represented in a 4-bit field. If 12 bits are adequate for representing the period phase, then each period of such a system can be coded in a 2-byte word, the period ID. This period ID can be sent in the header of each time-controlled message. If the period duration is to be changed dynamically in a specific application, then such a change can be realised by dynamically selecting a new conflict-free period ID in the header of a message. The freedom from conflict of this new period ID must be checked by an on-line message scheduler before sending.

If the result of a microcomponent is not required until a later point in time, then the processing speed of the microcomponent can be slowed down by influencing the hardware during operation in order to reduce its energy consumption. The on-line message scheduler can therefore calculate an optimum message schedule taking into account the expected time of the result, the energy consumption and the global communications load, and subsequently send a message to the hardware of the microcomponent in order to optimally adjust the processing speed and therefore the energy consumption.

As messages, which belong to different periods, are transmitted independently from and unaffected by one another, these messages can be sent to independent input ports of a node computer 111. With this method, it is therefore possible to control several independent receiving ports of a component by means of a single physical line 110.

The middleware software 213 copies outgoing event information, the timely transmission of which has to be guaranteed, from the application software 214 into the appropriate message store of the time-controlled communications controller 211. According to the invention, such a time-controlled message, which contains guaranteed event information, is only sent by the communications controller 214 if the content of this time-controlled message has been changed since the last time it was sent. We refer to such a time-controlled message, which is not sent regularly but only sporadically, as a sporadic time-controlled message (SZN). If a communications system, such as AT 411 498, for example, also transmits best-effort event messages, then the bandwidth, which is not used by sporadic time-controlled messages, can be used for transmitting best-effort event messages.

The middleware software 213 can read and handle the event information and state information from an incoming time-controlled message separately, and forward it separately to the application software 214. Event information is stored in a queue of the middleware software 213 and consumed when read by the user software 214. State information is stored in a dual-ported (DP) memory of the middleware software. A new version of the state information overwrites the older version. The state information is not read by the user software 214 in a consuming manner.

FIG. 3 shows the structure of a possible time format in a time-controlled system. The unit in which time is shown is based on the second standard, a presentation being chosen in the binary number system in order to identify a point in time. Each bit of this representation relates to a positive or negative power of two of the second. The start of GPS time is defined as being the start of the epoch. The representation of periods (period duration and period phase) is considerably simplified if only harmonic periods (see above) of the second are allowed. It is then sufficient to mark one bit of the time format of FIG. 3 in order to define the duration of the period (period bit). The phase of the period is defined by the bit pattern to the right of the period bit.

FIG. 4 shows the structure of an SoC (system-on-a-chip) 400, which contains four microcomponents according to FIG. 1. A communications channel 410 represents the connection to an external communications system. The channels 420 and 421 connect the SoC to the remote transducers in the process. In an SoC, the internal communications channel 100 between the microcomponents has a very high bandwidth. It is therefore possible to reserve a dedicated sporadic time-controlled message (SZN) a priori for each event message, and therefore to guarantee that all event messages are transported without conflict. As an SZN is not sent if no new event information has been produced within the last period, no energy is consumed in the chip for the transmission of messages when events do not occur. This saving of energy is of great economic advantage, particularly in the case of portable devices.

There can be different types of microcomponent in an SoC. A microcomponent can consist of a conventional computer with CPU, memory, real-time operating system and user software; another will be formed by a dedicated hardware block, e.g. a signal processor or a hard-wired state machine. All components must support the selected protocol for sending and receiving time-controlled messages.

The main advantage of the disclosed invention compared with the invention shown in EP 1 370 952 results from the energy saving when transmitting guaranteed event messages on an SoC. As the energy consumption of an SoC—particularly in the case of portable devices—is a very critical quantity, this invention is of great economic benefit.

1.-13. (canceled)

14. A method for transmitting event information in a distributed system including a plurality of nodes, the method comprising:
sending, by a sending node of the plurality of nodes, a time-controlled message including guaranteed event information using one of a set of periodic intervals snychronized between or among the plurality of nodes;
updating the time-controlled message, as a current time-controlled message, whenever the guaranteed event information changes;
determining, at each subsequent periodic interval, whether the current time-control message is different from a last sent time-controlled message;
if the current time-control message is different from the last sent time-controlled message, sending, by the sending node, the current time-controlled message in a respective, subsequent periodic interval;
storing, by at least one receiving node of the plurality of nodes, content of each sent time-controlled message; and
reading a content of each stored time-controlled message, wherein the stored content is stored until the stored content is read once.

15. The method of claim 14, wherein the guaranteed event information is information that is guaranteed to be received by the at least one receiving node by a predetermined time and best-effort event information is information that is not guaranteed to be received by the at least one receiving node by the predetermined time, the method further comprising:
responsive to the current time-control message being the same as the last sent time-controlled message, sending, by the sending node, the best-effort event information in the respective, subsequent periodic interval.

16. The method of claim 14, further comprising:
establishing durations of the time-controlled messages to be powers of two of a predetermined smallest interval.

17. The method of claim 16, wherein the established durations have a duration in seconds of either 2^{N} or 1/(2^{N}) where N is an integer.

18. The method of claim 14, further comprising the step of:
sending, from the sending node, sporadic state messages including state information such that a duration of one or more of the sporadic state messages is dynamically changed during operation of the sending node.

19. The method of claim 18, wherein the plurality of nodes are microcomponents, respectively, on a system-on-a-chip (SoC) and interconnected using a time-controlled communication system, the method further comprising:
changing, by one of the microcomponents functioning as a dynamic scheduler, the durations of the sporadic state messages.

20. The method of claim 19, wherein the step of changing the durations of the sporadic state messages includes optimizing, by the dynamic scheduler, dynamic schedules based on time response and minimum energy consumption of the SoC.

21. The method of claim 19, wherein responsive to the guaranteed event information not being sent during a respective, subsequent periodic interval, as a reserved transmission slot, dynamically sending best-effort event information in the reserved transmission slot.

22. A system-on-a-chip (SoC) for exchanging event information between a plurality of microcomponents, comprising:
a first microcomponent of the plurality of microcomponents for: (1) sending a time-controlled message including guaranteed event information using one of a set of periodic intervals synchronized between or among the plurality of microcomponents; (2) updating the time-controlled message, as a current time-controlled message, whenever the guaranteed event information changes; (3) determining, at each subsequent periodic interval, whether the current time-control message is different from a last sent time-controlled message; and (4) if the current time-control message is different from the last sent time-controlled message, sending the current time-controlled message in a respective, subsequent periodic interval; and
a second microcomponent of the plurality of microcomponents for storing in a queue content of each sent time-controlled message and for reading the content of each stored time-controlled message from the queue once.

23. The SoC of claim 22, wherein:
the guaranteed event information is information that is guaranteed to be received by the second microcomponent by a predetermined time and best-effort event information is information that is not guaranteed to be received by the second microcomponent by the predetermined time; and
the first microcomponent, responsive to the current time-control message being the same as the last sent time-controlled message, sends best-effort event information in the respective, subsequent periodic interval.

24. The SoC of claim 22, further comprising:
a time-controlled communication system on the SoC for interconnecting the first microcomponent with the second microcomponent.

25. The SoC of claim 22, wherein the first and second microcomponents are either a programmable computer including user software or a dedicated hardware unit configured to receive and/or to send the time-controlled messages.

26. The SoC of claim 22, wherein the first microcomponent sends sporadic state messages including state information such that a duration of one or more of the sporadic state messages is dynamically changed during operation.

27. The SoC of claim 26, wherein the first microcomponent functions as a dynamic scheduler to change the durations of the sporadic state messages.

28. The SoC of claim 27, wherein the first microcomponent optimizes dynamic schedules based on time response and minimum energy consumption of the SoC.

29. The SoC of claim 22, wherein the first microcomponent is configured to include a plurality of ports and the plurality of ports are supplied by a single physical line.

30. The SoC of claim 22, wherein the first microcomponent, responsive to the guaranteed event information not being sent during the respective, periodic interval, as a reserved transmission slot, dynamically sends best-effort event information in the reserved transmission slot.

31. A system for transmitting event information between a sending node and a receiving node in a distributed system of a plurality of nodes, comprising:
a communication manager of the sending node for sending a time-controlled message including guaranteed event information using one of a set of periodic intervals synchronized between or among the plurality of nodes;
a process manager for updating the time-controlled message, as a current time-controlled message, whenever the guaranteed event information changes such that the communication manager determines, at each subsequent periodic interval, whether the current time-control message is different from a last sent time-controlled message and if the current time-control message is different from the last sent time-controlled message, sends the current time-controlled message in a respective, subsequent periodic interval; and
a controller for storing in a queue content of each sent time-controlled message and for reading the content of each stored time-controlled message from the queue once.

32. The system of claim 31, further comprising:
a global scheduler for establishing durations of the time-controlled messages to be powers of two of a predetermined smallest interval such that the established durations have a duration in seconds of either 2^{N or} 1/(2^{N}) where N is an integer.

33. The system of claim 31, wherein (i) the guaranteed event information is information that is guaranteed to be received by the receiving node by a predetermined time and best-effort event information is information that is not guaranteed to be received by the receiving node by the predetermined time, and (ii) the communication manager, responsive to the current time-control message being the same as the last sent time-controlled message, sends the best-effort event information in the respective, subsequent periodic interval.

34. The system of claim 31, wherein the sending and receiving nodes are microcomponents, respectively, on a system-on-a-chip (SoC), the system further comprising:
a time-controlled communication system for interconnecting the microcomponents.

35. The system of claim 31, wherein each of the sending and receiving nodes are either a programmable computer including user software or a dedicated hardware unit configured to receive and/or to send the time-controlled messages.

36. The system of claim 31, wherein the sending node functions as a dynamic scheduler to change durations of sporadic state messages by optimizing dynamic schedules based on time response and minimum energy consumption of the SoC.

37. The system of claim 31, wherein the sending node, responsive to the guaranteed event information not being sent during the respective, subsequent periodic interval, as a reserved transmission slot, dynamically sends best-effort event information in the reserved transmission slot.
